(19) United States
(12) Patent Application Publication
(10) Pub. No.: US 2008/0240579 A1
(43) Pub. Date: Oct. 2, 2008

(54) VIDEO DISCRIMINATION METHOD AND VIDEO DISCRIMINATION APPARATUS

(75) Inventor: Nobuyoshi Enomoto, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/017,807

(22) Filed: Jan. 22, 2008

(30) Foreign Application Priority Data
Mar. 30, 2007 (JP) 2007-094626

(51) Int. Cl. G06K 9/62

(52) U.S. Cl. 382/224

(57) ABSTRACT

A video discrimination apparatus executes learning processing by acquiring a plurality of sample video pictures and information indicating a category of each sample video picture, classifying sample video pictures of each category into subcategories, determining a subcategory with a closest relation to each sample video picture for each combination of subcategories, which are selected one each from the respective categories, and calculating, for each combination of subcategories, a video discrimination parameter based on the frequency of occurrence of matches between a category to which the subcategory determined to have the closest relation to each sample video picture belongs and a category of that sample video picture. The video discrimination apparatus executes video discrimination processing for classifying video pictures into categories based on the integration result of a plurality of video discrimination parameters obtained by the learning processing.

### CROSS-REFERENCE TO RELATED APPLICATIONS

This application is based upon and claims the benefit of priority from prior Japanese Patent Application No. 2007-094626, filed Mar. 30, 2007, the entire contents of which are incorporated herein by reference.

### BACKGROUND OF THE INVENTION

1. Field of the Invention

The invention relates to a video discrimination method and a video discrimination apparatus, which are used in a system for monitoring areas in the back or side of a vehicle, a system for monitoring the presence/absence of intruders based on a video picture obtained by capturing an image of a monitoring area, a system for making personal authentication based on biological information obtained from a video picture such as a face image and the like, or the like, and which are used to classify video pictures.

2. Description of the Related Art

In general, a system for monitoring areas in the back or side of a vehicle, a system for monitoring the presence/absence of intruders based on a video picture obtained by capturing an image of a monitoring area, a system for making personal authentication based on biological information obtained from a video picture such as a face image and the like, or the like, does not normally comprise a function of discriminating whether or not an input video picture is a desired one which is assumed to be handled by the system.

For example, JP-A 2001-43377 (KOKAI) and JP-A 2001-43352 (KOKAI) describe techniques for discriminating whether or not an input video picture is a desired one. JP-A 2001-43377 (KOKAI) discloses a technique for comparing the luminance distribution of a video picture in the horizontal direction with that in an abnormal state to discriminate whether a video picture is normal or abnormal. JP-A 2001-43352 (KOKAI) describes a technique for discriminating a video picture which has a small number of edges in the horizontal direction and a high average luminance as an abnormal video picture.

That is, JP-A 2001-43377 (KOKAI) or JP-A 2001-43352 (KOKAI) describes the technique for discriminating an abnormal video picture caused by the influence of the luminance level such as backlight or smear from a normal video picture based on the luminance distributions or edge amounts of video pictures in the horizontal direction. However, the aforementioned system often does not suffice to discriminate normal and abnormal video pictures based only on the luminance levels of video pictures in the horizontal direction.

As a method of retrieving a specific video picture from a database which stores a plurality of video pictures, a method of retrieving, from the database, video pictures having luminance histograms which are most similar to those of a video picture as a query is known. In this case, the similarities between the luminance histograms of a video picture as a query and those of video pictures stored in the database are calculated, and a video picture having the highest similarity is selected as a retrieval result.

Also, a method of selecting a video picture which is most similar to that as a query based on the similarities between feature amounts (statistical information) extracted from the video picture as a query and those extracted from video pictures stored in a database is available. Such method is used in retrieval processing based on feature amounts obtained from face images of persons included in video pictures, retrieval processing based on feature amounts obtained from outer appearance images of vehicles included in video pictures, or the like. As calculation methods of similarities used to retrieve video pictures, those using simple similarities, partial spaces, discrimination analysis, and the like are available.

However, when a natural video picture captured in a normal environment is used as a query of retrieval, similarities must be calculated in consideration of environmental variations and the like. In such case, since the processing for computing similarities becomes complicated, a long processing time is required to execute processing for retrieving a video picture similar to a query video picture from a database, and it often becomes difficult to obtain a desired retrieval result.

### BRIEF SUMMARY OF THE INVENTION

One aspect of the invention has as its object to provide a video discrimination method and a video discrimination apparatus, which can efficiently classify video pictures.

A video discrimination method according to one aspect of the invention is a method of classifying video pictures into a plurality of categories, comprising: acquiring a plurality of sample video pictures; acquiring information indicating a category of each acquired sample video picture; classifying sample video pictures of each category into subcategories; determining a subcategory with the closest relation to each sample video picture for each combination of subcategories which are selected one each from the categories; calculating, for each combination of subcategories, a video discrimination parameter based on a frequency of occurrence of matches between a category to which the subcategory determined to have the closest relation to each sample video picture belongs and a category of that sample video picture; and classifying video pictures into the respective categories based on an integration result of a plurality of video discrimination parameters obtained for respective combinations of subcategories.

A video discrimination apparatus according to one aspect of the invention is an apparatus for classifying video pictures into a plurality of categories, comprising: a video acquisition unit configured to acquire video pictures; a user interface configured to input information indicating a category of each sample video picture acquired by the video acquisition unit; a classifying unit configured to further classify, into subcategories, sample video pictures of each category which are classified based on the information indicating the category input from the user interface; a determination unit configured to determine a subcategory with a closest relation to each sample video picture for each combination of subcategories which are selected one each from the categories classified by the classifying unit; a calculation unit configured to calculate, for each combination of subcategories, a video discrimination parameter based on a frequency of occurrence of matches between a category to which the subcategory determined to have the closest relation to each sample video picture belongs and a category of that sample video picture; and a discrimination unit configured to discriminate a category of a video picture acquired by the video acquisition unit based on an integration result of a plurality of video discrimination parameters calculated for respective combinations of subcategories by the calculation unit.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the preferred embodiments given below, serve to explain the principles of the invention.

FIG. 1 is a schematic block diagram showing an example of the arrangement of a video discrimination apparatus;

FIG. 2 is a flowchart for explaining the overall sequence of processing in the video discrimination apparatus;

FIG. 3 is a flowchart for explaining the sequence of learning processing in the video discrimination apparatus;

FIG. 4 is a conceptual diagram for explaining the feature amounts of input video pictures based on sample video pictures classified into subcategories; and

FIG. 5 is a flowchart for explaining the sequence of video discrimination processing.

### DETAILED DESCRIPTION OF THE INVENTION

Embodiments of the invention will be described hereinafter with reference to the accompanying drawings.

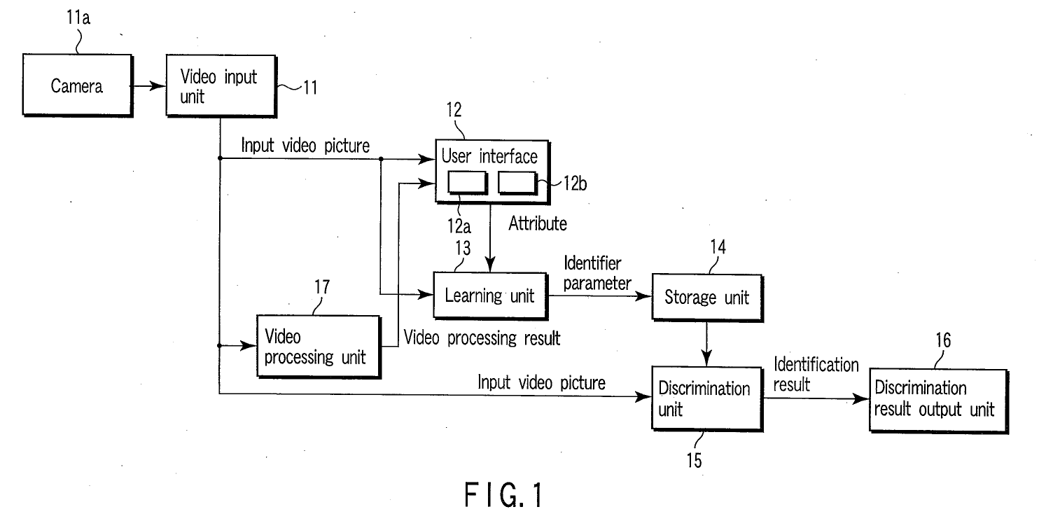

FIG. 1 schematically shows the arrangement of a video discrimination apparatus according to an embodiment of the invention.

This video discrimination apparatus classifies input video pictures. The video discrimination apparatus of this embodiment classifies input video pictures into predetermined classes. For example, the video discrimination apparatus discriminates whether an input video picture is a compliant video picture (normal video picture) which meets predetermined criteria or a noncompliant video picture (abnormal video picture). The video discrimination apparatus is assumed to be applied to a system for monitoring areas in the back or side of a vehicle using a video picture (on-vehicle monitoring system), a system for monitoring the presence/absence of intruders based on a video picture of a monitoring area (intruder monitoring system), a system for making personal authentication based on biological information extracted from a video picture (biological authentication system), or the like. This embodiment mainly assumes a video discrimination apparatus applied to an on-vehicle monitoring system which monitors areas in the back or side of a vehicle using a video picture taken behind or aside the vehicle.

As shown in FIG. 1, the video discrimination apparatus comprises a video input unit 11, user interface 12, learning unit 13, storage unit 14, discrimination unit 15, discrimination result output unit 16, and video monitoring unit (video processing unit) 17. The learning unit 13, discrimination unit 15, and video monitoring unit 17 are functions implemented when an arithmetic unit executes programs stored in a memory.

The video input unit 11 is an interface device used to acquire a video picture. An input interface is used to input a video picture captured by a camera 11a. The input interface may input either an analog video signal or a digital video signal.

For example, when an analog video picture is acquired from a camera, the video input unit 11 comprises an analog-to-digital converter. In the video input unit 11, the analog-to-digital converter converts an analog video signal input from the input interface into a digital video signal of a predetermined format. When a digital video signal is acquired from a camera, the video input unit 11 includes a converter used to convert the digital video signal input from the input interface into a digital video signal of the predetermined format. As the format of the digital video signal, for example, each pixel may be expressed by monochrome data of 8 to 16 bit lengths, or a monochrome component may be extracted from R, G, and B signals of 8 to 16 bit lengths which form a color video signal.

The video input unit 11 includes a memory and the like in addition to the video input interface. The memory of the video input unit 11 stores information indicating the status of video processing to be described later (for example, information indicating whether or not learning processing of the learning unit 13 has been done).

The user interface 12 comprises a display device 12a, input device 12b, and the like. The display device 12a displays a video picture input by the video input unit 11, the processing result of the discrimination unit 15 (to be described later), operation guides for the user, and the like. The input device 12b has, for example, a mouse, keyboard, and the like. The input device 12b has an interface used to output information input using the mouse or keyboard to the learning unit 13. For example, in learning processing to be described later, the user inputs an attribute (normal or abnormal) of a video picture displayed on the display device 12a using the input device 12b of the user interface 12. In this case, the user interface 12 outputs information (attribute information) indicating the attribute input using the input device 12b to the learning unit 13.

The learning unit 13 executes learning processing required to classify video pictures input from the video input unit 11. The learning unit 13 comprises an arithmetic unit, memory, interface, and the like. More specifically, the learning processing by the learning unit 13 is a function implemented when the arithmetic unit executes a program stored in the memory. For example, as the learning processing, the learning unit 13 calculates parameters (identifier parameters), which specify an identifier used to classify video pictures input from the video input unit 11, based on the attribute information input from the user interface 12. The identifier parameters calculated by the learning unit 13 are stored in the storage unit 14.

The storage unit 14 saves various data used in video discrimination processing. For example, the storage unit 14 stores the identifier parameters calculated by the learning unit 13 and the like.

The discrimination unit 15 executes processing (video discrimination processing) for classifying input video pictures. That is, the discrimination unit 15 discriminates one of predetermined categories to which an input video picture is classified. For example, the discrimination unit 15 classifies input video pictures using identifiers specified by the identifier parameters and the like stored in the storage unit 14.

The discrimination result output unit 16 outputs the discrimination result of the discrimination unit 15. For example, the discrimination result output unit 16 displays the discrimination result of the discrimination unit 15 on the display device 12a of the user interface 12, outputs it to an external device (not shown), or outputs it via a loudspeaker (not shown).

The video processing unit (video monitoring unit) 17 executes predetermined processing for an input video picture. For example, when this video discrimination apparatus is applied to the on-vehicle monitoring system, the video processing unit 17 executes processing for monitoring areas in the back or side of a vehicle using an input video picture. When this video discrimination apparatus is applied to the intruder monitoring system, the video processing unit 17 executes processing for detecting an intruder from an input video picture of the management area. When this video discrimination apparatus is applied to the biological authentication system, the video processing unit 17 executes processing for extracting biological information from an input video picture, and collating the extracted biological information with that stored in advance in a database (for example, processing for determining if a maximum similarity is equal to or higher than a predetermined value).

The overall processing in the aforementioned video discrimination apparatus will be described below.

This video discrimination apparatus has two processing modes, i.e., a learning processing mode and video determination mode. In the learning processing mode, the apparatus executes processing for setting parameters required to discriminate an input video picture based on sample video pictures and information which is designated by the user and indicates a category (normal or abnormal video picture) of each sample video picture. In the video determination mode, the apparatus determines (classifies) the category (normal or abnormal video picture) of the input video picture based on the parameters as the processing result in the learning processing mode.

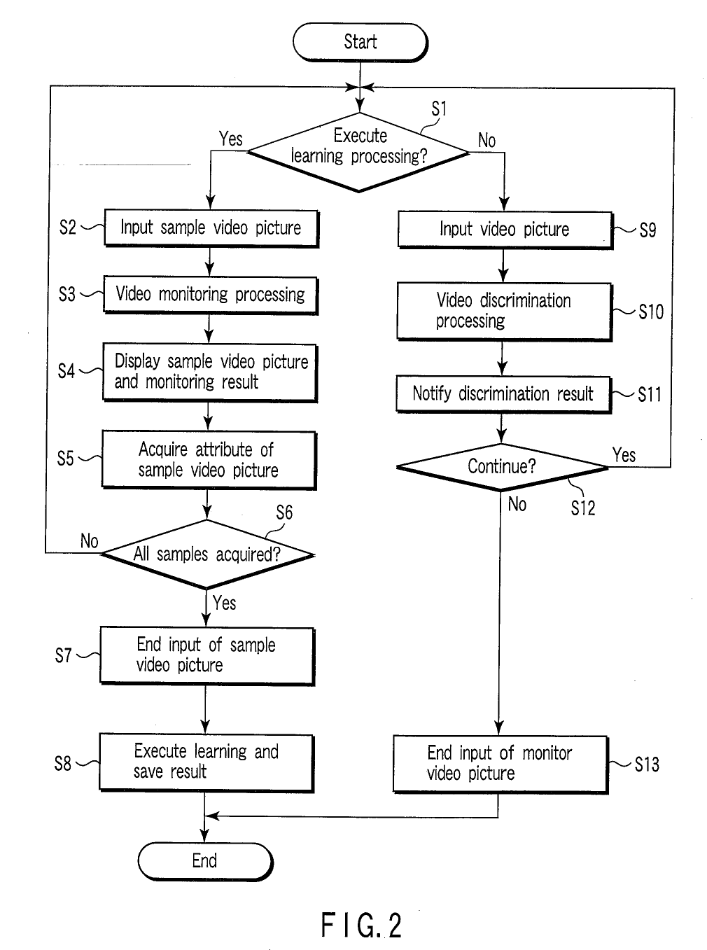

FIG. 2 is a flowchart for explaining the sequence of the overall processing in the video discrimination apparatus. In the flowchart shown in FIG. 2, steps S1 to S8 indicate the sequence of operations in the learning processing mode, and steps S1 and S9 to S13 indicate the sequence of operations in the video determination mode.

The sequence of the overall processing will be described below with reference to the flowchart shown in FIG. 2.

The video input unit 11 checks whether or not the video discrimination apparatus is set in the learning processing (whether or not the apparatus is executing learning processing) (step S1). If the apparatus is in the learning processing mode (YES in step S1), the video input unit 11 inputs a video picture supplied from the camera 11a as a sample video picture (step S2). In this case, the video input unit 11 supplies the sample video picture to the video processing unit 17 and user interface 12. Upon reception of the sample video picture, the video processing unit 17 applies predetermined processing to the video picture input as the sample video picture (step S3).

For example, upon execution of the video monitoring processing for monitoring a change in the video picture (for example, the processing for monitoring areas in the back or side of a vehicle or the processing for detecting an intruder in a monitoring area), the video processing unit 17 detects a change in state or the like from the sample video picture, and supplies the detection result to the user interface 12. Upon execution of the processing for retrieving a video picture similar to the input video picture from a database (not shown) (for example, personal retrieval or personal authentication based on biological information such as a face image or the like), the video processing unit 17 retrieves a video picture similar to the sample video picture from the database, and supplies the retrieval result to the user interface 12.

The video processing unit 17 supplies the result of the aforementioned processing for the sample video picture to the user interface 12.

The user interface 12 displays, on the display device 12a, the processing result for the sample video picture supplied from the video processing unit 17 together with the sample video picture supplied from the video input unit 11 (step S4). In this case, the user interface 12 prompts the user to designate the category (attribute) of the sample video picture displayed on the display device 12a (step S5). For example, the user interface 12 displays, on the display device 12a, the sample video picture and the processing result of the video processing unit 17, and also a message that prompts the user to designate the category of the sample video picture using the input device 12b. In response to this message, the user decides the category (e.g., a normal or abnormal video picture) of the sample video picture displayed on the display device 12a, and designates that decision result as the category (attribute) of that sample video picture using the input device 12b. The user interface 12 supplies the information (attribute information) designated using the input device 12b to the learning unit 13 together with the sample video picture.

The learning unit 13 stores the sample video picture and the attribute information designated by the user in a memory (not shown). After the sample video picture and attribute information are stored, the learning unit 13 checks if sample video pictures as many as the predetermined number (or predetermined amount) are obtained (step S6). In this case, the learning unit 13 may check if the number of sample video pictures whose attribute information is designated has reached a predetermined value, if sample video pictures for a predetermined time period have been captured, or if sample video pictures as many as the predetermined number for each category have been collected.

If the learning unit 13 determines that sample video pictures as many as the predetermined number are not obtained (NO in step S6), the process returns to step S2, and the video input unit 11 executes processing for inputting a sample video picture from the camera 11a. The learning unit 13 repeats the learning processing in steps S2 to S6 until sample video pictures as many as the predetermined number are obtained.

If the learning unit 13 determines that sample video pictures as many as the predetermined number are obtained (YES in step S6), the video input unit 11 ends the processing for inputting a sample video picture from the camera 11a (step S7). Upon completion of the input of sample video pictures, the learning unit 13 executes learning processing based on a plurality of sample video pictures and their attribute information stored in the memory (step S8). The learning processing of the learning unit 13 calculates identifier parameters required to classify video pictures into a plurality of categories (e.g., normal or abnormal) based on the plurality of sample video pictures and their attribute information, and stores the calculated identifier parameters in the storage unit 14. Note that the learning processing will be described in detail later.

On the other hand, if the apparatus is not in the learning processing mode, i.e., it is in the video discrimination processing mode (NO in step S1), the video input unit 11 inputs a video picture supplied from the camera 11a as a video picture to be processed (step S9 ). In this case, the video input unit 11 supplies the input video picture to the video processing unit 17 and discrimination unit 15. Thus, the video processing unit 17 executes predetermined processing (monitoring processing or the like) for the video picture input from the video input unit 11.

The discrimination unit 15 executes video discrimination processing for the input video picture using identifiers specified by the identifier parameters and the like stored in the storage unit 14 (step S10). This video discrimination processing classifies the input video picture into a category learned in the learning processing.

For example, when the learning unit 13 executes the learning processing for identifying if an input video picture is a normal or abnormal video picture, the storage unit 14 stores identifier parameters required to identify the input video picture. Therefore, the discrimination unit 15 identifies using identifiers whether the video picture input from the video input unit 11 is normal or abnormal.

The result of the aforementioned video discrimination processing by the discrimination unit 15 is supplied to the discrimination result output unit 16. In this way, the discrimination result output unit executes processing for outputting the discrimination result of the category for the input video picture (information indicating the category of the input video picture) to the user interface 12, or an external device or the like (not shown) (step S11).

The processes in steps S9 to S11 are continuously repeated until the video input unit 11 inputs a video picture to be processed in the video discrimination processing (YES in step S12).

For example, if the video discrimination processing is executed for a video picture input in the video processing mode all the time (YES in step S12), the processes in steps S9 to S11 are repetitively executed for video pictures sequentially input in the video processing mode. If the video discrimination processing is to end (NO in step S12), the video input unit 11 ends the video input processing (step S13).

The learning processing will be described below.

As described above, the learning unit 13 executes the learning processing based on a plurality of sample video pictures and attribute information of sample video pictures designated by the user. In this learning processing, the learning unit 13 calculates information required to classify video pictures into a plurality of categories. In this embodiment, assume that the learning unit 13 calculates identifier parameters as information required to determine one of normal and abnormal video pictures as categories. As described above, the user designates using the user interface 12 whether the sample video picture input from the video input unit 11 is “normal” or “abnormal” (that is, he or she designates the category (attribute) of each sample video picture). The attribute information indicating the category of each sample video picture designated by the user is stored in the learning unit 13 together with the sample video picture. In this way, the learning unit 13 can statistically process the plurality of stored sample video pictures and their attribute information. In this case, the learning unit 13 calculates information (identifier parameters) required to identify whether an input video picture is “normal” or “abnormal”.

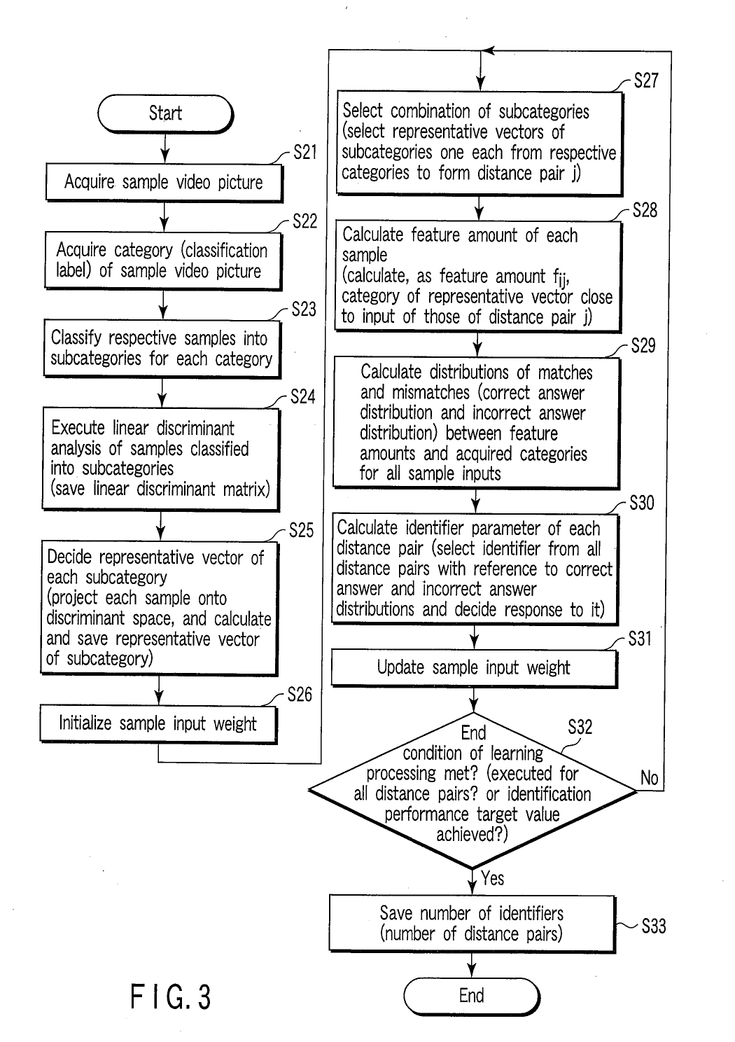

FIG. 3 is a flowchart for explaining the sequence of the learning processing.

That is, the learning unit 13 stores a sample video picture input from the video input unit 11 and attribute information of that sample video picture designated by the user via the user interface 12 in the memory (not shown) (steps S21 and S22).

Assume that the learning unit 13 converts the input sample video picture into a feature vector to be described later (to be referred to as a “sample input feature vector” hereinafter), and stores that vector in the memory (not shown) in step S21. Note that the sample input feature vector uses a feature amount extracted from the entire image at a certain moment in the sample video picture. For example, the sample input feature vector may use the luminance values of respective pixels in each frame image that forms the sample video picture as a one-dimensional vector. The sample input feature vector may use the frequency distribution of luminance values of each image, that of an inter-frame difference image, that of optical flow directions, and the like, which are combined into one vector. The sample input feature vector may extract vectors as the feature amounts from an image sequence sampled for a plurality of frames, and may handle them together as a vector obtained from these images.

The learning unit 13 divides the sample input feature vectors as sample video pictures in each category into a plurality of subcategories (step S23). That is, the learning unit 13 classifies the sample input feature vectors of each category stored in the memory into subcategories. This division method may use a general statistical clustering method such as a known K-means method or the like.

After the sample input feature vectors of the respective categories are classified into subcategories, the learning unit 13 executes linear discriminant analysis of the sample input feature vectors for each subcategory. The learning unit 13 stores a matrix (linear discriminant matrix) indicating a linear discriminant space obtained as a result of the linear discriminant analysis in the memory (not shown) (step S24).

Note that linear discriminant analysis is a type of conversion that minimizes a ratio (Wi/Wo) of a variance Wi in a subcategory and a variance Wo between subcategories. With this conversion, the linear discriminant analysis enlarges the distances between subcategories and reduces those between vectors in each subcategory. That is, the linear discriminant analysis produces an effect of improving the identification performance upon determining a subcategory to which a given input video picture belongs.

The learning unit 13 projects the sample input feature vectors for respective categories onto the linear discriminant space. With this processing, the learning unit 13 calculates and saves representative vectors of respective subcategories (step S25).

Note that a plurality of different representative vector calculation methods are available. In this embodiment, a representative vector of each subcategory is calculated by applying the linear discriminant analysis to the sample input feature vectors of that subcategory.

Note that the representative vector of each subcategory is generated by projecting barycentric vectors of the sample input feature vectors in each subcategory onto the linear discriminant space. The representative vector of each subcategory is assigned attribute information indicating the category (one of “normal” and “abnormal” in this case) to which that subcategory belongs.

As another representative vector calculation method, for example, the following method may be used. That is, vectors (feature vectors) indicating the aforementioned feature amounts are extracted from respective frame images in the sample video picture, and these feature vectors are classified into subcategories in the same manner as described above. The feature vectors in each subcategory undergo principal component analysis to represent them by a partial space obtained from top n (n is an integer less than the number of subcategories) eigenvectors.

The learning unit 13 initializes a value indicating a sample input weight. After the sample input weight is initialized, the learning unit 13 repeats processes in steps S27 to S31 until a condition checked in step S32 is met. Note that the process in step S26 initializes the sample input weight updated by the processes in steps S27 to S31. Also, the process in step S26 is that indicated by (a) to be described later.

The processes in steps S27 to S31 determine a response to each sample input video picture and update the sample input weight. Assume that the learning unit 13 calculates a vector (to be referred to as a “sample input projection vector” hereinafter) obtained by projecting each sample input feature vector onto the linear discriminant space. By comparing the distances between the sample input projection vectors and representative vectors of subcategories, the learning unit 13 selects an identifier (weak identifier) required to discriminate a category (“normal” or “abnormal” category in this case), to which the sample input video picture belongs, from a plurality of candidates one by one, thereby determining a response to the sample input video picture.

In order to determine the response to the sample input video picture, it is required to extract the representative vectors of subcategories, which are to be compared with the sample input projection vector of a sample input video picture, one by one from each category, and to obtain the frequency distributions for feature amounts (frequency distributions of the categories) as given by equations (5) and (6) (to be described later). Therefore, as the processing result of steps S27 to S32, information indicating the representative vectors of subcategories, which are to undergo distance comparison in identifiers (identification numbers assigned to representative vectors of subcategories), and the frequency distributions are saved in the storage unit 14 as identifier parameters.

That is, after the sample input weight is initialized (step S26), the learning unit 13 selects a representative vector of a subcategory which belongs to a given category, and that of a subcategory which belongs to another category, and defines a pair of these representative vectors as a distance pair j (step S27). After the two representative vectors of the distance pair j are selected, the learning unit 13 sets the category of the representative vector that has a smaller distance to a sample input feature vector i, of the two representative vectors of the distance pair j, as a feature amount fᵢⱼ of the sample input feature vector i (step S28).

The learning unit 13 checks if the category as the feature amount f of each of all the sample input feature vectors matches the category (attribute) designated by the user using the user interface 12. Based on these checking results, the learning unit 13 calculates and saves the distributions of matches and mismatches between the feature amounts of the sample input feature vectors and the category designated by the user (step S29). After the distributions of matches and mismatches are calculated, the learning unit 13 selects a specific feature amount (identifier) from all distance pairs with reference to the distributions of matches (correct answers) and mismatches (incorrect answers), and determines a response to that feature amount (step S30). The learning unit 13 then updates the sample input weight (step S31).

Upon updating the sample input weight, the learning unit 13 checks if the predetermined condition required to determine whether or not to end the learning processing is met. For example, the condition required to determine whether or not to end the learning processing is either the number of times of repetitive execution of the processes in steps S27 to S31 matches the total number of identifiers, or the accuracy rate for all the sample input video pictures using all selected identifiers (a rate of matches between the feature amounts of the sample input feature vectors and the category designated by the user) exceeds a predetermined target value.

If it is determined that the condition required to end the learning processing is not met (NO in step S32), the learning unit 13 executes steps S27 to S31 again. That is, the learning unit 13 repetitively executes steps S27 to S31 until the predetermined condition is met.

If it is determined that the condition required to end the learning processing is met (YES in step S32), the learning unit 13 ends the processes in steps S27 to S31, and saves the number of repetitions of steps S27 to S31, i.e., the number of selected identifiers in the storage unit 14 as an identifier parameter (step S33).

Various methods can be applied to the processes in steps S26 to S31. This embodiment will explain an implementation example using a known Adaboost algorithm. With this algorithm, the processes in steps S26 to S31 are implemented by processes (a) to (d) to be described below. Briefly speaking, this algorithm evaluates responses of identifiers to all sample inputs, selects one of the identifiers, and updates respective sample input weights according to the distribution of the response results. (a) The learning unit 13 equalizes a probabilistic distribution D(i) as each sample input weight by:

D(i)=1/M equation (1)

where M: the number of sample inputs

This process corresponds to that in step S26 in FIG. 3.

(b) The learning unit 13 generates a distance pair (N: the number of combinations of subcategories) from a representative vector i of a subcategory (corresponding to the process in step S27 in FIG. 3), and obtains a feature amount of a sample input feature vector based on the checking result of the magnitude relationship about the distances of that distance pair from the representative vectors of subcategories (corresponding to the process in step S28 in FIG. 3).

(c) Next, the learning unit 13 calculates the frequency distributions about the feature amounts of all the sample input feature vectors (corresponding to the process in step S29 in FIG. 3), and determines a response hₜ(x) to an identifier selected in each repetition (round) t (corresponding to the process in step S30 in FIG. 3).

(d) The learning unit 13 then updates the probabilistic distribution Dₜ(i) as the sample input weight using hₜ(x) according to:

Dₜ₊₁(i)=Dₜ(i)exp(−yᵢhₜ(xᵢ)) equation (2)

where t: a repetition round

This process corresponds to that in step S31 in FIG. 3.

The repetitive processing (learning processing) from (a) to (d) ends when the aforementioned predetermined condition is met. Step S32 above exemplifies, as the predetermined condition required to end the repetitive processing, the two conditions: the number of repetitions matches the total number of identifiers, and the accuracy rate for all sample input video pictures using the selected identifiers exceeds a predetermined target value. The latter of these conditions is calculated by calculating a combined result H(x) of identifiers selected until the timing of the repetition (round) t for all the sample input video pictures using:

$$H ( x ) = sign ( {\sum }_{t} ( {h}_{t} ( x ) - b ) ) \qquad equation ( 3 )$$

where sign(a) is the sign of a, and b is a bias constant, and calculating and evaluating the accuracy rate for all the sample input video pictures using the combined result H(x). In this case, H(x)<0 indicates “abnormal” and H(x)≧0 indicates “normal”.

The processes (b) and (c) of the processes (a) to (d) will be described in detail below.

A case will be assumed wherein it is discriminated if a given sample input video picture belongs to category A or B. In this case, the learning unit 13 selects one each subcategory from the categories, and extracts representative vectors Va (this subcategory belongs to category A: “normal” in this example) and Vb (this subcategory belongs to category B: “abnormal” in this example) of the selected subcategories.

For example, the learning unit 13 outputs the following feature amount fj based on the distances between the representative vectors Va and Vb of the two subcategories and an input vector V.

If the distance to the vector Va (category A)<the distance to the vector Vb (category B), the learning unit 13 outputs “fj=1”.

If the distance to the vector Vb (category B)<the distance to the vector Va (category A), the learning unit 13 outputs “fj=−1”.

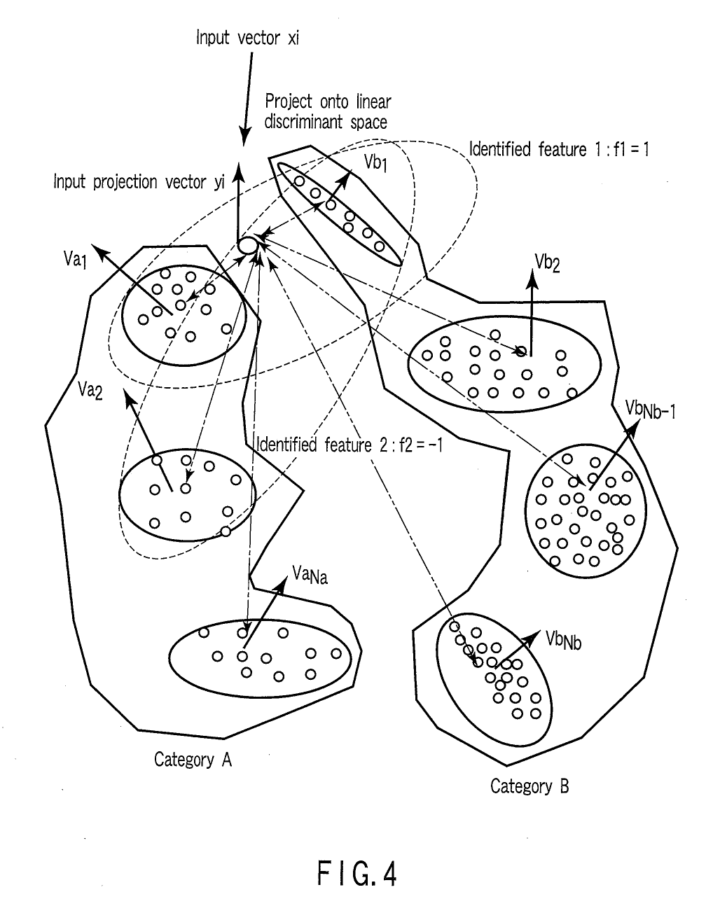

FIG. 4 is a conceptual diagram for explaining the aforementioned feature amount fj.

In the example shown in FIG. 4, as subcategories of category A, those which have vectors Va₁, Va₂, . . . , Vaₙₐ as representative vectors are provided. As subcategories of category B, those which have vectors Vb₁, Vb₂, . . . , Vbₙₐ as representative vectors are provided.

If the representative vector Va₁ of a subcategory of category A and the representative vector Vb₁ of a subcategory of category B form distance pair 1, since the distance between an input projection vector yᵢ and the vector Vb₁ is larger than that between the input projection vector yᵢ and vector Va₁, a feature amount f₁ is set to be “f₁=1”.

If the representative vector Va₂ of a subcategory of category A and the representative vector Vb₁ of the subcategory of category B form distance pair 2, since the distance between the input projection vector yᵢ and the vector Va₂ is larger than that between the input projection vector yᵢ and vector Vb₁, a feature amount f₂ is set to be “f₂=−1”.

The aforementioned feature amount fᵢ can be generated up to those as many as the number of combinations of the pairs of representative vectors of respective subcategories. That is, in the case of discriminating the two categories, as described above, if the first category has Nn subcategories, and the second category has Na subcategories, the upper limit of the number of combinations (i.e., that of the number of feature amounts) is “N=Nn×Na”.

After the aforementioned feature amounts fᵢ are obtained, the learning unit 13 calculates a distribution F (yᵢ=1|fⱼ) of the frequencies of occurrence of matches (the frequencies of occurrence of correct answers) between the feature amount fᵢ obtained by a given identifier for each sample input Xᵢ and the category designated by the user (the category designated by the user is equal to the feature amount fᵢ), and a distribution F (yᵢ=−1fⱼ) of the frequencies of occurrence of mismatches (the frequencies of occurrence of incorrect answers) (the category designated by the user is not equal to the feature amount fᵢ) using the following equations.

For example, the frequency distribution as a pass/fail distribution associated with feature amounts fⱼ=−1 and 1 for sample inputs xᵢ of category A is generated by:

F(yᵢ=1|fⱼ)=Σ_{((i|xiεfjΛyj=1)}D(i) equation (4)

The frequency distribution as a pass/fail distribution associated with feature amounts fⱼ=−1 and 1 for sample inputs xᵢ of category B is generated by:

F(yᵢ=−1|fⱼ)=Σ_{(i|xiεfjΛyj=-1)}D(i) equation (5)

Note that yᵢ is a value (correct answer value) indicating the correct category of a sample input xᵢ. Therefore, yᵢ has the following meanings.

xᵢ belongs to category A: yᵢ=1

Xᵢ belongs to category B: yᵢ=−1

Using the aforementioned frequency distributions, the k-th identifier hₖ(x) can be configured by:

$${h}_{k} ( x ) = \frac{1}{2} \frac{log ( F ( {y}_{i} = 1 \vert {f}_{j} ) )}{log ( F ( {y}_{i} = - 1 \vert {f}_{j} ) )} \qquad equation ( 6 )$$

Next, the learning unit 13 selects an identifier which outputs an optimal response to the current input distribution from all the identifiers based on the condition that minimizes a loss Z given by:

z=2Σ_{f}_{ⱼ}_{=0,1}{square root over ((F(y=1|fⱼ)F(y=−1|fⱼ)))} equation (7)

The selected identifier is an identifier hₜ(x) in the repetition (round) t.

The video determination processing for classifying input video pictures will be described in detail below.

As the video determination processing, the discrimination unit 15 integrates the identifiers obtained by the aforementioned learning processing, and discriminates the category of an input video picture using the integrated identifiers. Note that the following explanation will be given under the assumption that an input video picture belongs to either category A (normal video picture) or category B (abnormal video picture) described above. That is, the discrimination unit 15 executes the processing for discriminating if an input video picture is a normal or abnormal video picture, using the identifier parameters saved in the storage unit 14 as the learning result of the aforementioned learning processing.

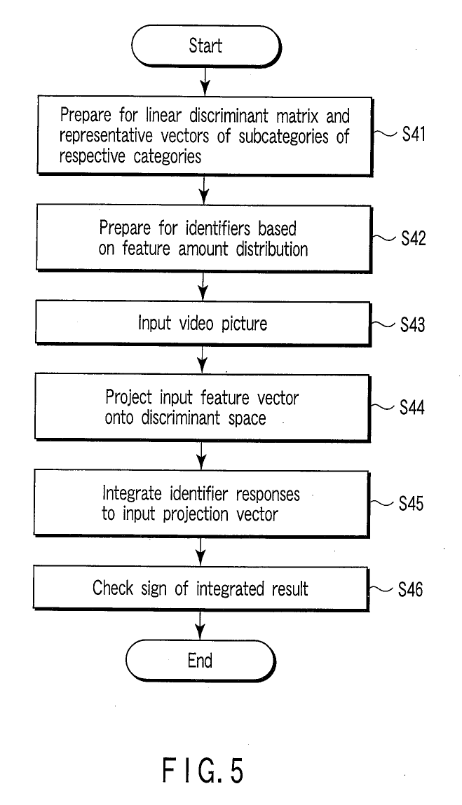

FIG. 5 is a flowchart for explaining the sequence of the video determination processing.

The discrimination unit 15 maps the linear discriminant matrix and representative vectors of respective subcategories, which are saved in the storage unit 14 as the learning result of the aforementioned learning processing, on a processing memory (not shown) (step S41).

Furthermore, the discrimination unit 15 maps the representative vector numbers of the subcategories as the identifier parameters that specify respective identifiers and the frequency distributions of the feature amounts, which are saved in the storage unit 14 by the aforementioned learning processing, on the processing memory (not shown) (step S42). As a result, the identifier parameters as a plurality of identifiers required to discriminate an input video picture are prepared on the processing memory of the discrimination unit 15.

The video input unit 11 inputs a video picture captured by the camera 11a, and supplies the input video picture to the discrimination unit 15 (step S43). The discrimination unit 15 extracts an input feature vector from the input video picture as in the aforementioned learning processing, and generates an input projection vector by projecting it onto each subcategory representative space (step S44).

After the input projection vector is generated, the discrimination unit 15 calculates responses of the respective identifiers to the input video picture based on the identifier parameters mapped on the memory.

That is, the discrimination unit 15 extracts representative vectors of a plurality of (two or more) subcategories based on a given identifier parameter. After the representative vectors of the plurality of subcategories are extracted, the discrimination unit 15 determines a category to which a representative vector with a minimum distance from the input projection vector of those vectors belongs. The discrimination unit 15 sets the determined category as a feature amount fⱼ of the input video picture by that identifier. After the feature amount fⱼ of the input video picture is calculated, the discrimination unit 15 substitutes the calculated feature amount fⱼ in equation (6), thus calculating a response of that identifier to the input video picture.

The discrimination unit 15 executes the aforementioned processing for calculating a response to the input video picture for respective identifiers. In this way, after the responses to the input video picture are calculated, the discrimination unit 15 calculates a sum total of the responses of the identifiers to the input video picture (step S45). After the sum total of the responses of the identifiers are calculated, the discrimination unit 15 checks the sign of the calculated sum total (step S46). The sign of the sum total of the responses of the respective identifiers is the determination result of the category. That is, the discrimination unit 15 discriminates the category of the input video picture based on the sign of the sum total of the responses of the respective identifiers to the input video picture.

As described above, the video discrimination apparatus can classify input video pictures into a plurality of categories with high precision. Also, the video discrimination apparatus can speed up the processing for classifying input video pictures into a plurality of categories. Furthermore, the video discrimination method used in the video discrimination apparatus can be applied to various systems using video pictures.

For example, in a video recognition system to which the aforementioned video discrimination method is applied, since the learning processing can be executed using results indicating if the processing may or may not function well, causes of operation failures of the internal processing of a recognition processing method in that recognition system need not be examined for each processing step. Therefore, the video discrimination method can be easily applied to various recognition systems using video pictures or database retrieval processing for determining a category to which an input video picture belongs. Upon application of the video discrimination method, the video discrimination processing of a recognition system using video pictures or the video database retrieval processing can operate at high speed and with high precision.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video discrimination method for classifying video pictures into a plurality of categories, the method comprising:
acquiring a plurality of sample video pictures;
acquiring information indicating a category of each acquired sample video picture;
classifying sample video pictures of each category into subcategories;
determining a subcategory with a closest relation to each sample video picture for each combination of subcategories which are selected one each from the categories;
calculating, for each combination of subcategories, a video discrimination parameter based on a frequency of occurrence of matches between a category to which the subcategory determined to have the closest relation to each sample video picture belongs and a category of that sample video picture; and
classifying video pictures into the respective categories based on an integration result of a plurality of video discrimination parameters obtained for respective combinations of subcategories.

2. The method according to claim 1, wherein the video discrimination parameter for each combination of subcategories is calculated based on a correct answer frequency distribution of matches between the category to which the subcategory determined to have the closest relation to each sample video picture belongs and the category of that sample video picture, and an incorrect answer frequency distribution of mismatches between the categories.

3. The method according to claim 2, wherein the frequency distribution of matches and the frequency distribution of mismatches are weighted based on a probabilistic distribution according to the number of acquired sample video pictures.

4. The method according to claim 3, wherein the probabilistic distribution is updated based on the video discrimination parameter which is calculated sequentially for each combination of subcategories.

5. The method according to claim 1, which further comprises:
converting each sample video picture into a feature vector; and
deciding a representative vector which represents the feature vectors of sample video pictures of each subcategory for that subcategory, and
in which the determining the subcategory determines a subcategory of a representative vector which has a shortest distance to a vector of each sample video picture as the subcategory with the closest relation to that sample video picture.

6. A video discrimination apparatus for classifying video pictures into a plurality of categories, the apparatus comprising:
a video acquisition unit configured to acquire video pictures;
a user interface configured to input information indicating a category of each sample video picture acquired by the video acquisition unit;
a classifying unit configured to further classify, into subcategories, sample video pictures of each category which are classified based on the information indicating the category input from the user interface;
a determination unit configured to determine a subcategory with a closest relation to each sample video picture for each combination of subcategories which are selected one each from the categories classified by the classifying unit;
a calculation unit configured to calculate, for each combination of subcategories, a video discrimination parameter based on a frequency of occurrence of matches between a category to which the subcategory determined to have the closest relation to each sample video picture belongs and a category of that sample video picture; and
a discrimination unit configured to discriminate a category of a video picture acquired by the video acquisition unit based on an integration result of a plurality of video discrimination parameters calculated for respective combinations of subcategories by the calculation unit.

7. The apparatus according to claim 6, wherein the calculation unit calculates the video discrimination parameter for each combination of subcategories based on a correct answer frequency distribution of matches between the category to which the subcategory determined to have the closest relation to each sample video picture belongs and the category of that sample video picture, and an incorrect answer frequency distribution of mismatches between the categories.

8. The apparatus according to claim 7, which further comprises a setting unit configured to set a probabilistic distribution according to the number of sample video pictures acquired by the video acquisition unit, and
in which the calculation unit weights the correct answer frequency distribution and the incorrect answer frequency distribution based on the probabilistic distribution set by the setting unit.

9. The apparatus according to claim 8, which further comprises an update unit configured to update the probabilistic distribution based on the video discrimination parameter which is calculated sequentially by the calculation unit for each combination of subcategories.

10. The apparatus according to claim 6, which further comprises:
a conversion unit configured to convert each sample video picture into a feature vector; and
a decision unit configured to decide a representative vector which represents the feature vectors of sample video pictures of each subcategory for that subcategory, and
in which the determination unit determines a subcategory of a representative vector which has a shortest distance to a vector of each sample video picture.
